(19) United States
(12) Patent Application Publication
(10) Pub. No.: US 2021/0325919 A1
(43) Pub. Date: Oct. 21, 2021

(54) MIXING VALVE WITH PROFILED PLUNGER FOR LINEARIZED TEMPERATURE OUTPUT

(71) Applicant: Haier US Appliance Solutions, Inc., Wilmington, DE (US)

(72) Inventors: Gregory Hutchison, Shelbyville, KY (US); Alan George Constance, Jeffersonville, IN (US); Jonathan D. Nelson, Louisville, KY (US)

(21) Appl. No.: 16/851,214

(22) Filed: Apr. 17, 2020

(51) Int. Cl. G05D 23/13; F16K 11/044

(52) U.S. Cl. CPC G05D 23/1393; G05D 23/1919; F16K 11/044

(57) ABSTRACT

A mixing valve for a water heater appliance includes a valve body that defines a mixing chamber, the mixing chamber being in fluid communication with a cold water inlet conduit and a hot water inlet conduit. The cold water inlet conduit defines a profiled junction defining an inlet orifice and a plunger valve is mounted within the valve body and is moveable relative to the inlet orifice to regulate a flow of water through the inlet orifice. A distal end of the plunger valve defines a profiled sealing face, the profiled sealing face and the inlet orifice being cooperative to permit a flow rate that is substantially proportional to a valve position.

### FIELD OF THE INVENTION

The present subject matter relates generally to mixing valves for water heater appliances, and more particularly, to mixing valves that facilitate linearized temperature output.

### BACKGROUND OF THE INVENTION

Certain water heater appliances include a tank therein. Heating elements, such as gas burners, electric resistance elements, or induction elements, heat water within the tank during operation of such water heater appliances. During operation, relatively cold water flows into the tank, and the heating elements operate to heat such water to a predetermined temperature. In particular, the heating elements generally heat water within the tank to a very high temperature. A mixing valve mixes the relatively hot water with relatively cold water in order to bring the temperature of such water down to suitable and/or more usable temperatures. For example, mixing valves may adjust the ratio of hot and cold water to supply heated water at an output temperature suitable for showering, washing hands, etc.

Conventional mixing valves include one or more plungers that regulate the flows of hot and/or cold water traveling through hot and cold inlet orifices, respectively. In this manner, the plunger adjusts the flow area through the orifices and thus the flow rate of water therethrough. Notably, however, conventional plunger valves exhibit non-linear changes in the flow rates, particularly as the plunger is reaching a fully closed position. Thus, the use of such plungers in mixing valves may result in difficulty in adjusting outlet temperatures of a flow of water, particularly when the valve approaches a fully open or fully closed position for either hot or cold water.

Accordingly, a water heater appliance with features for ensuring improved water temperature output would be useful. More specifically, a mixing valve for a water heater appliance that facilitates linearized temperature output that is proportional to a position of a plunger valve would be particularly beneficial.

### BRIEF DESCRIPTION OF THE INVENTION

Advantages of the invention will be set forth in part in the following description, or may be apparent from the description, or may be learned through practice of the invention.

In one exemplary aspect of the present disclosure, a water heater appliance is provided including a tank defining an interior volume for holding water, a cold water supply configured for directing cold water into the interior volume of the tank, a heating assembly for heating water within the tank, and a hot water supply configured for directing heated water out of the interior volume of the tank. A mixing valve is in fluid communication with the cold water supply and the hot water supply, the mixing valve being configured for selectively mixing the heated water from the hot water supply and the cold water from the cold water supply. The mixing valve includes a valve body that defines a mixing chamber, an inlet conduit that is fluidly coupled to the mixing chamber at an inlet orifice, and a plunger valve mounted within the valve body, the plunger valve being moveable relative to the inlet orifice to regulate a flow of water through the inlet orifice, wherein a distal end of the plunger valve defines a profiled sealing face, the profiled sealing face and the inlet orifice being cooperative to permit a flow rate that is substantially proportional to a valve position.

In another exemplary aspect of the present disclosure, a mixing valve for a water heater appliance is provided. The mixing valve includes a valve body that defines a mixing chamber, a hot water inlet conduit providing fluid communication between the mixing chamber and a hot water supply, a cold water inlet conduit providing fluid communication between the mixing chamber and a cold water supply, the cold water inlet conduit comprising a profiled junction defining an inlet orifice, and a plunger valve mounted within the valve body, the plunger valve being moveable relative to the inlet orifice to regulate a flow of water through the inlet orifice, wherein a distal end of the plunger valve defines a profiled sealing face, the profiled sealing face and the inlet orifice being cooperative to permit a flow rate that is substantially proportional to a valve position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of a water heater system including the exemplary water heater appliance of FIG. 1 according to an exemplary embodiment of the present subject matter.

FIG. 3 provides a perspective view of a mixing valve for use with the exemplary water heater appliance of FIG. 1 according to an exemplary embodiment of the present subject matter.

FIG. 4 provides a cross sectional view of the exemplary mixing valve of FIG. 3 according to an exemplary embodiment of the present subject matter.

FIG. 5 provides a perspective, cross sectional view of the exemplary mixing valve of FIG. 3 according to an exemplary embodiment of the present subject matter.

FIG. 6 provides a close-up, cross sectional view of a plunger and an inlet orifice of the exemplary mixing valve of FIG. 3 according to an exemplary embodiment of the present subject matter.

FIG. 7 provides a schematic view of the exemplary plunger engaging the exemplary inlet orifice of FIG. 6 to restrict a flow of water according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

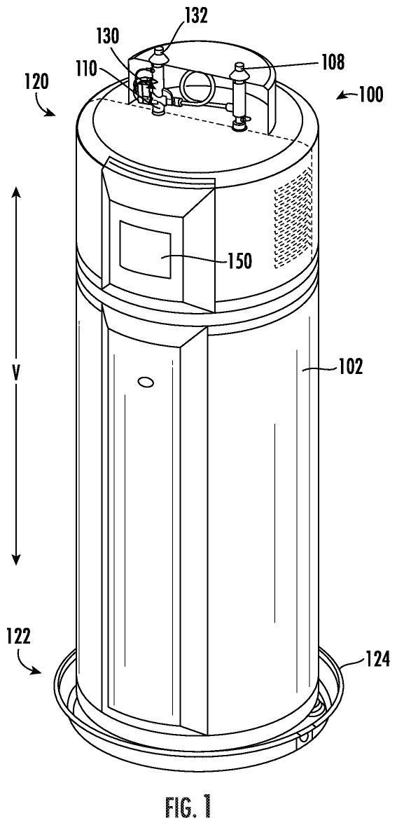

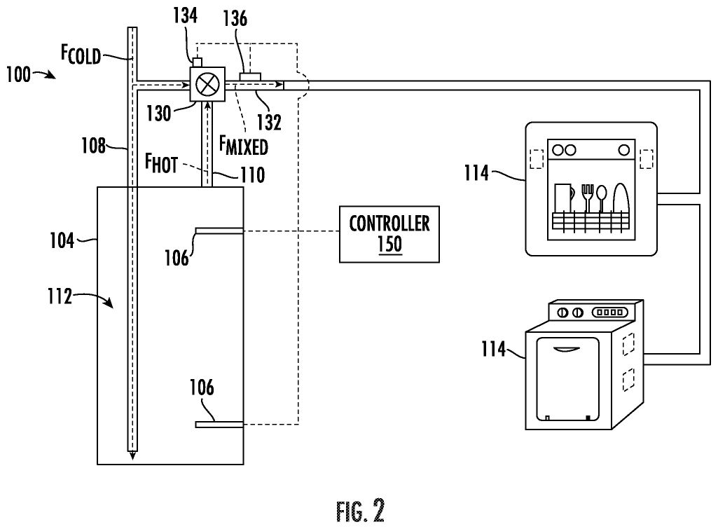

FIG. 1 provides a perspective view of a water heater appliance 100 according to an exemplary embodiment of the present subject matter. Water heater appliance 100 includes a casing 102. A tank 104 (FIG. 2) and heating elements 106 (FIG. 2) are positioned within casing 102 for heating water therein. Heating elements 106 may include a gas burner, a heat pump, an electric resistance element, a microwave element, an induction element, a sealed heat pump system or any other suitable heating element, heating assembly, or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water supply 108 and a hot water supply 110 that are both in fluid communication with an interior volume or a chamber 112 (FIG. 2) defined by tank 104. As an example, cold water from a water source, e.g., a municipal water supply or a well, can enter water heater appliance 100 through cold water supply 108 (shown schematically with arrow labeled From in FIG. 2). From cold water supply 108, such cold water can enter chamber 112 of tank 104 wherein it is heated with heating elements 106 to generate heated water. Such heated water can exit water heater appliance 100 at hot water supply 110 and, e.g., be supplied to a water consuming device 114 (FIG. 2). In this regard, water consuming devices 114 may include any suitable plumbing fixture, household appliance, or any other suitable device configured to draw water from water heater appliance 100, such as a bath, shower, sink, or any other suitable fixture. It should be appreciated that the terms “cold” and “hot” are only intended to refer to the relative temperatures of flows of water or to identify conduits transporting such flows. These terms are not intended to require that a particular conduit provide water at a specific temperature or within a specific temperature range.

Water heater appliance 100 extends longitudinally between a top portion 120 and a bottom portion 122 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. A drain pan 124 is positioned at bottom portion 122 of water heater appliance 100 such that water heater appliance 100 sits on drain pan 124. Drain pan 124 sits beneath water heater appliance 100 along the vertical direction V, e.g., to collect water that leaks from water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 130 and a mixed water conduit 132. Mixing valve 130 is in fluid communication with cold water supply 108, hot water supply 110, and mixed water conduit 132. As discussed in greater detail below, mixing valve 130 is configured for selectively directing water from cold water supply 108 and hot water supply 110 into mixed water conduit 132 in order to regulate an output temperature of water within mixed water conduit 132.

As an example, mixing valve 130 can selectively adjust between a first position and a second position. In the first position, mixing valve 130 can permit a first flow rate of relatively cool water from cold water supply 108 (shown schematically with arrow labeled F_{cold} in FIG. 2) into mixed water conduit 132 and mixing valve 130 can also permit a first flow rate of relatively hot water from hot water supply 110 (shown schematically with arrow labeled Fₕₒₜ in FIG. 2) into mixed water conduit 132. In such a manner, water within mixed water conduit 132 (shown schematically with arrow labeled F_{mixed} in FIG. 2) can have a first particular temperature when mixing valve 130 is in the first position.

Similarly, mixing valve 130 can permit a second flow rate of relatively cool water from cold water supply 108 into mixed water conduit 132 and mixing valve 130 can also permit a second flow rate of relatively hot water from hot water supply 110 into mixed water conduit 132 in the second position. The first and second flow rates of the relatively cool water and relatively hot water are different such that water within mixed water conduit 132 can have a second particular temperature when mixing valve 130 is in the second position. In such a manner, mixing valve 130 can regulate the temperature of water within mixed water conduit 132 and adjust the temperature of water within mixed water conduit 132 between the first and second particular temperatures.

It should be understood that, in certain exemplary embodiments, mixing valve 130 is adjustable between more positions than the first and second positions. In particular, mixing valve 130 may be adjustable between any suitable number of positions in alternative exemplary embodiments. For example, mixing valve 130 may be infinitely adjustable in order to permit fine-tuning of the temperature of water within mixed water conduit 132. Mixing valve 130 may be an electronic mixing valve. In addition, mixing valve 130 may be positioned within casing 102, e.g., above tank 104. Thus, mixing valve 130 may be integrated within water heater appliance 100. According to still other exemplary embodiments, mixing valve 130 may be positioned remote from water heater appliance 100, e.g., proximate a water consuming device.

Water heater appliance 100 also includes a position sensor 134. Position sensor 134 is configured for determining a position of mixing valve 130. Position sensor 134 can monitor the position of mixing valve 130 in order to assist with regulating the temperature of water within mixed water conduit 132. For example, position sensor 134 can determine when mixing valve 130 is in the first position or the second position in order to ensure that mixing valve 130 is properly or suitably positioned depending upon the temperature of water within mixed water conduit 132 desired or selected. Thus, position sensor 134 can provide feedback regarding the status or position of mixing valve 130.

According to the illustrated exemplary embodiment, water heater appliance 100 includes a mixed water conduit flow detector or temperature sensor 136 for detecting a temperature of mixed water passing through mixed water conduit 132. According to alternative embodiments, water heater appliance may further include a cold water supply flow detector or temperature sensor, a hot water supply flow detector or temperature sensor, or any other suitable sensors for detecting the flow and/or temperature of water within water heater appliance 100.

Water heater appliance 100 further includes a controller 150 that is configured for regulating operation of water heater appliance 100. Controller 150 is in, e.g., operative communication with heating elements 106, mixing valve 130, position sensor 134, and temperature sensor 136. Thus, controller 150 can selectively activate heating elements 106 in order to heat water within chamber 112 of tank 104. Similarly, controller 150 can selectively operate mixing valve 130 in order to adjust a position of mixing valve 130 and regulate a temperature of water within mixed water conduit 132.

Controller 150 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 150 can be positioned at a variety of locations. In the exemplary embodiment shown in FIG. 1, controller 150 is positioned within water heater appliance 100, e.g., as an integral component of water heater appliance 100. In alternative exemplary embodiments, controller 150 may positioned away from water heater appliance 100 and communicate with water heater appliance 100 over a wireless connection or any other suitable connection, such as a wired connection.

Controller 150 can operate heating elements 106 to heat water within chamber 112 of tank 104. As an example, a user can select or establish a set-point temperature for water within chamber 112 of tank 104, or the set-point temperature for water within chamber 112 of tank 104 may be a default value. Based upon the set-point temperature for water within chamber 112 of tank 104, controller 150 can selectively activate heating elements 106 in order to heat water within chamber 112 of tank 104 to the set-point temperature for water within chamber 112 of tank 104. The set-point temperature for water within chamber 112 of tank 104 can be any suitable temperature. For example, the set-point temperature for water within chamber 112 of tank 104 may be between about one hundred and forty degrees Fahrenheit and about one hundred and eighty-degrees Fahrenheit.

Controller 150 can also operate mixing valve 130 to regulate the temperature of water within mixed water conduit 132. For example, controller 150 can adjust the position of mixing valve 130 in order to regulate the temperature of water within mixed water conduit 132. As an example, a user can select or establish a predetermined target temperature of mixing valve 130, or the target temperature of mixing valve 130 may be a default value. The target temperature of mixing valve 130 can be any suitable temperature. For example, the target temperature of mixing valve 130 may be between about one hundred degrees Fahrenheit and about one hundred and twenty degrees Fahrenheit. In particular, the target temperature of mixing valve 130 may be selected such that the target temperature of mixing valve 130 is less than the set-point temperature for water within chamber 112 of tank 104.

Based upon the target temperature of mixing valve 130, controller 150 can adjust the position of mixing valve 130 in order to change or tweak a ratio of relatively cool water flowing into mixed water conduit 132 from cold water supply 108 and relatively hot water flowing into mixed water conduit 132 from hot water supply 110. More specifically, controller 150 can implement any suitable control strategy or algorithm to regulate the temperature of water within mixed water conduit 132. In such a manner, mixing valve 130 can utilize water from cold water supply 108 and hot water supply 110 to regulate the temperature of water within mixed water conduit 132.

Referring now generally to FIGS. 3 through 7, a mixing valve 200 for use with water heater appliance 100 will be described according to an exemplary embodiment of the present subject matter. For example, mixing valve 200 may be the same or similar to mixing valve 130 described above. Although mixing valve 200 is described herein as being used with water heater appliance 100, it should be appreciated that aspects of the present subject matter may be used in any other water heater appliance, in any other mixing valve, or in any other application where it is desirable to regulate a flow of water through an orifice. The exemplary embodiment described herein is only exemplary and is not intended to limit the scope of the present subject matter.

As illustrated, mixing valve 200 includes a valve body 202 that defines an internal volume or mixing chamber 204. In general, mixing chamber 204 is in fluid communication with hot water supply 110 to receive a flow of hot water and cold water supply 108 to receive a flow of cold water. The flow of hot water and the flow of cold water mix within mixing chamber 204 and are discharged downstream through mixed water conduit 132 (e.g., to one or more water consuming devices 114). More specifically, mixing valve 200 may include one or more inlet conduits that are fluidly coupled to or formed as part of valve body 202. In this regard, according to the illustrated embodiment, mixing valve 200 includes a hot water inlet conduit 206 that provides fluid communication between mixing chamber 204 and a hot water supply (e.g., such as hot water supply 110 or interior volume 112 through a direct connection) and a cold water inlet conduit 208 that provides fluid communication between mixing chamber 204 and a cold water supply (e.g., such as cold water supply 108). In this manner, mixing chamber 204 may be supplied with both hot and cold flows of water.

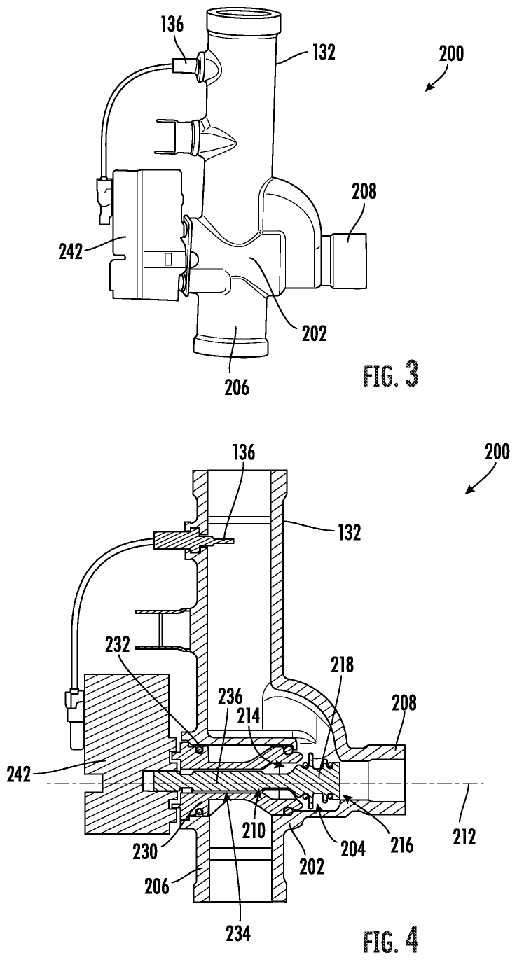

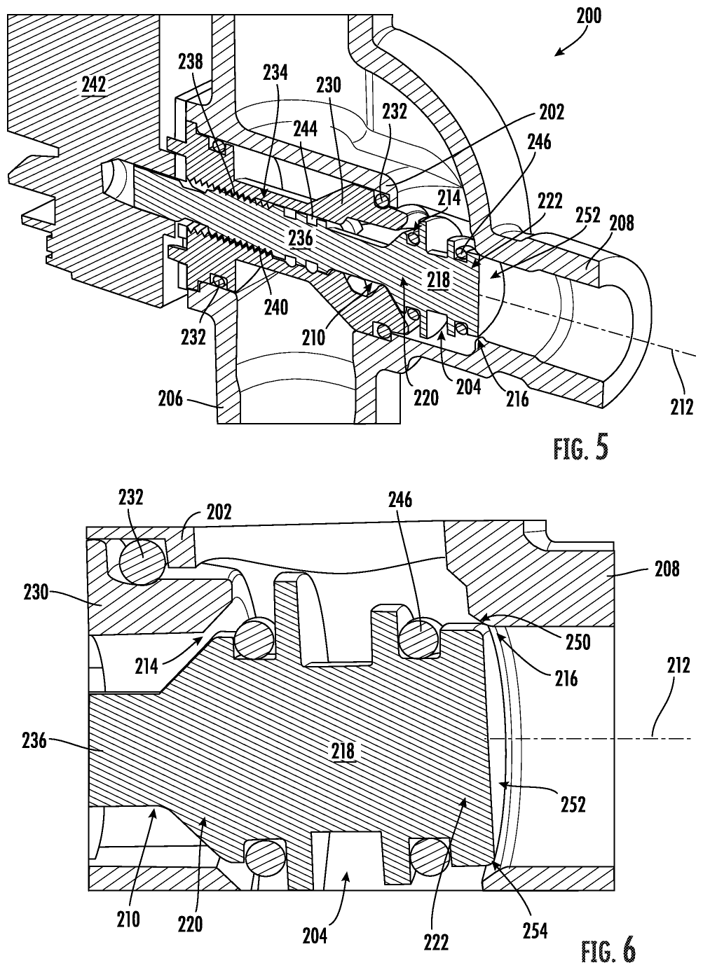

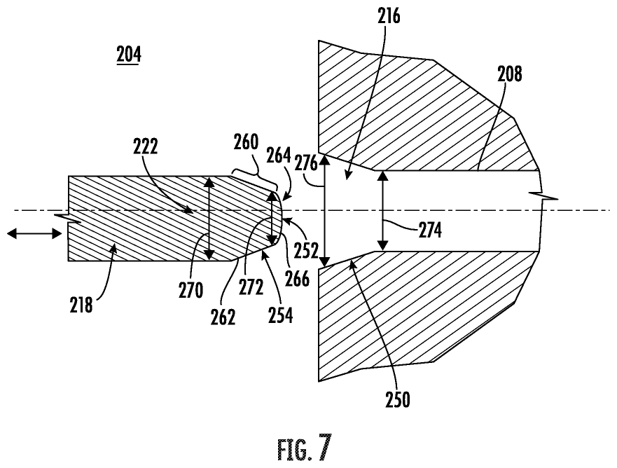

Notably, mixing valve 200 further includes features for adjusting the portions of hot and cold water flowing through mixing chamber 204. In this regard, as best illustrated in FIGS. 4 and 5, mixing valve 200 includes a plunger valve 210 that is movable along a translation axis 212 to selectively restrict or otherwise regulate the flow area through a hot water inlet orifice 214 and a cold water inlet orifice 216. According to the illustrated embodiment, plunger valve 210 includes a plunger head 218 that is positioned within mixing chamber 204 and defines a hot water sealing portion 220 and an opposite cold water sealing portion 222. In addition, hot water inlet orifice 214 and cold water inlet orifice 216 are positioned on opposite sides of plunger head 218 relative to the translation axis 212. In this manner, moving plunger valve 210 in one direction (e.g., to the right as shown in FIG. 6) will cause plunger head 218 to restrict the flow of cold water through cold water inlet orifice 216 while increasing the flow of hot water through hot water inlet orifice 214. Similarly, moving plunger valve 210 in the other direction (e.g., to the left as shown in FIG. 6) will cause plunger head 218 to restrict the flow of hot water through hot water inlet orifice 214 while increasing the flow of cold water through cold water inlet orifice 216. Although an exemplary valve configuration as shown, it should be appreciated that aspects of the present subject matter may apply to other valve types and configurations. For example, according to alternative embodiments, mixing valve 200 may include more than one restriction device for independently restricting the flow of hot water in the flow of cold water.

Mixing valve 200 may include any suitable mechanism or device for moving plunger valve 210 along the translation axis 212 within mixing chamber 204. For example, according to the illustrated embodiment, mixing valve 200 includes a drive body 230 that is fixed within valve body 202 immediately upstream of hot water inlet orifice 214. Drive body 230 may include one or more drive body seals 232, such as O-rings, that are designed to prevent leaks and direct the flow hot water only through hot water inlet orifice 214. In addition, drive body 230 defines a central bore 234 through which a shaft 236 of plunger valve 210 is received. Drive body 230 further defines stationary threads 234 that protrude from an inner wall of central bore 234 and shaft 236 of plunger valve 210 defines complementary plunger threads 240 that engage stationary threads 238. In this manner, when plunger valve 210 is rotated, plunger threads 240 and stationary threads 238 engage each other and cause plunger valve 210 to move along the translation axis 212.

According to the illustrated embodiment, mixing valve 200 further includes a drive motor 242 that is operably coupled to plunger valve 210. In this regard, drive motor 242 may be a stepper motor that is configured for selectively rotating plunger valve 210 such that threads 238, 240 move plunger valve 210 along the translation axis 212 to regulate the flow of hot water and the flow of cold water as desired. As used herein, “motor” may refer to any suitable drive motor and/or transmission assembly for rotating a system component. For example, drive motor 242 may be a brushless DC electric motor, a stepper motor, or any other suitable type or configuration of motor. Alternatively, for example, drive motor 242 may be an AC motor, an induction motor, a permanent magnet synchronous motor, or any other suitable type of AC motor. In addition, drive motor 242 may include any suitable transmission assemblies, clutch mechanisms, or other components.

According to the illustrated embodiment, mixing valve 200 may further include additional seals for improving flow regulation and reducing leaks within mixing valve 200. In this regard, for example, mixing valve 200 includes one or more shaft seals 244 that are positioned around shaft 236 within central bore 234, e.g., to prevent water from leaking out of mixing valve 200 through central bore 234. In addition, mixing valve may include one or more head seals 246 that are positioned around hot water sealing portion 220 and cold water sealing portion 222 of plunger head 218, e.g., for improving flow regulation through hot water inlet orifice 214 and cold water inlet orifice 216, respectively. According to the illustrated embodiment, shaft seals 244 and head seals 246 are rubber 0-rings. However, alterative sealing mechanisms or devices may be used while remaining within the scope of the present subject matter.

According to exemplary embodiments, mixing valve 200 may be operatively coupled with any suitable controller, such as controller 150, for regulating the position of plunger valve 210 and the temperature of the flow of mixed water within mixed water conduit 132. In this regard, as explained above, mixing valve 200 may further include a temperature sensor 136 that is operably coupled with mixed water conduit 132 for detecting a temperature of the flow of mixed water. Controller 150 may then selectively operate drive motor 242 to rotate plunger valve 210 to maintain a desired temperature.

Notably, as explained briefly above, the flow of hot water through hot water inlet orifice 214 and the flow of cold water through cold water inlet orifice 216 may not vary proportionally or linearly with the valve position of plunger valve 210. In this regard, according to exemplary embodiments, it may be desirable for a flow rate of the flow of water through inlet orifices 214, 216 to vary proportionally with the valve position. In this regard, if plunger valve 210 is moved from a full cold position (e.g., all the way to the left in FIG. 6, where hot water inlet orifice 214 is fully sealed or closed) to a full hot position (e.g., all the way to the right in FIG. 6, where cold water inlet orifice 216 is fully sealed or closed) at a substantially constant rate, it may be desirable that the flow of cold water also decreases in a linear of substantially constant fashion. However, conventional valve designs result in jumps or nonlinearities in the water flow response to valve movement. Aspects of the present subject matter are directed towards generating a linear or otherwise more desirable flow of water through inlet orifices 214, 216. Although the focus of the discussion below is the regulation of flow through cold water inlet orifice 216, it should be appreciated that aspects of the present subject matter may also apply to hot water inlet orifice 214 as well as to any other suitable orifices, valve types, or mixing valves.

As best shown in FIGS. 6 and 7, mixing valve 200 may include inlet conduits 206, 208 that define profiled junctions and plunger head 218 may define sealing portions 220, 222. Together, these profiled junctions and sealing portions facilitate a linearized flow output relative to the position of plunger valve 210. For example, as shown, cold water inlet conduit 208 may define a profiled junction 250 that defines cold water inlet orifice 216. In this regard, instead of having a squared shoulder at the point where the inlet conduit meets the mixing chamber, profiled junction 250 may be curved, arcuate, filleted, parabolic, or any other shape for facilitating improved linearization of the flow rate profile. In addition, a distal end 252 of plunger head 218 of plunger valve 210 may define a profiled sealing face 254. In this regard, instead of plunger head 218 being substantially cylindrical from end to end, the distal end 252 may be curved, arcuate, filleted, parabolic, or any other suitable shape.

Notably, if the cold water inlet orifice 216 is substantially cylindrical with a sharp shoulder and the plunger head 218 is substantially cylindrical with a sharp corner, a flow rate of the flow of cold water passing through cold water inlet orifice 216 may vary in a nonlinear manner relative to valve position. By contrast, if one or both of the plunger head 218 and cold water inlet conduit 208 define profiled sealing faces or surfaces, the effect of the valve position on the flow rate may be carefully designed or tailored for a particular situation. Although the exemplary embodiment described herein includes profiled junction 250 and profiled sealing face 254, it should be appreciated that according to alternative embodiments, only one of plunger head 218 and cold water inlet conduit 208 need be curved, tapered, etc.

As explained above, profiled sealing face 254 of plunger valve 210 and profiled junction 250 of cold water inlet orifice 216 are cooperative with each other to permit a flow rate through cold water inlet orifice 216 that is substantially proportional to a valve position of plunger valve 210. In this regard, a flow area is generally defined between profiled junction 250 and profiled sealing face 254. By appropriately designing the shapes of profiled junction 250 and profiled sealing face 254, this flow area for a given position of plunger valve 210 may be precisely controlled, e.g., such that the flow area varies proportionally with the valve position to generate a linear relationship between valve position and flow rate. Thus, as plunger valve 210 approaches a full hot position (e.g., as cold water inlet orifice 216 is nearing the fully closed position), the flow rate of cold water may not experience any undesirable jumps or fluctuations.

Notably, it should be appreciated that profiled junction 250 and profiled sealing face 254 may define any suitable shape, size, and geometry for achieving the desired flow rate through cold water inlet orifice 216. For example, as described above, both profiled junction 250 and profiled sealing face 254 may include a curved, arcuate, filleted, or parabolic shape. In addition, it should be appreciated that profiled junction 250 and profiled sealing face 254 may include one or more regions having different shapes. For example, as best shown in FIG. 7, profiled sealing face 254 defines a first region 260 with a conical taper 262 and a second region 264 with an arcuate profile 266. It should be appreciated that profiled junction 250 may have similar regions or may have an entirely different shape.

As used herein, the term “conical taper” and the like is intended to refer generally to the shape of plunger head 218 or cold water inlet orifice 216 that varies from a cylindrical cross-section having a larger diameter to a cylindrical cross-section having a smaller diameter. For example, a conical taper in the cold water inlet orifice 216 would result in an increase diameter closer to mixing chamber 204. By contrast, a conical taper on plunger head 218 would result in a larger diameter away from cold water inlet orifice 216 and a smaller diameter toward cold water inlet orifice 216. Similarly, arcuate or filleted profile 266 may have any suitable radius or multiple radii while remaining within the scope of the present subject matter.

Specifically, as shown in FIG. 7, a schematic view of plunger head 218 and cold water inlet orifice 216 is illustrated according to an exemplary embodiment. As shown, plunger head 218 defines a first diameter 270 and a second diameter 272, the second diameter 272 being measured at distal end 252, e.g., closer to cold water inlet orifice 216. Similarly, cold water inlet orifice 216 defines a first diameter 274 and a second diameter 276, the second diameter 276 being positioned proximate mixing chamber 204, e.g., downstream relative to the flow of cold water. According to the illustrated embodiment, first diameters 270, 274 and second diameters 272, 276 may vary by any suitable amount or percentage. For example, second diameter 272 may be between about 1% and 95%, between about 5% and 75%, between about 10% and 50%, between about 20 and 40%, of first diameter 270. According to an exemplary embodiment, first diameter 274 may be between about 1% and 95%, between about 5% and 75%, between about 10% and 50%, between about 20 and 40%, or about 30%, of second diameter 276. It should be appreciated that the shapes and profiles of profiled junction 250 and profiled sealing face 254 may vary while remaining within the scope of the present subject matter.

The electronic mixing valve 200 described above enables improved flow regulation and precise temperature control. According to the exemplary illustrated embodiment, the mixing valve 200 includes a single flow restrictor (e.g., plunger valve 210) for regulating the flow of both hot and cold water to achieve a desired mixed outlet temperature. Specifically, as the hot supply wetted cross section is increased the cold supply is decreased, and vice versa. According to exemplary embodiments, because mixing valve 200 delivers water primarily from the hot inlet, it may be desirable to precisely regulate the flow of cold water.

Notably, when restricting flow in circular openings, the hot and cold openings may change from a full circular opening to an annular opening as the flow is restricted (e.g., as plunger valve 210 engages cold water inlet orifice 216). Aspects of the present subject matter are directed to the profile of plunger valve 210, cold water inlet orifice 216, or both. Specifically, these geometries are designed to balance the mixing between hot and cold wetted cross section in a linear manner while considering overall outlet flowrate. For example, use of a parabolic profile on the cold water inlet side of the mixing valve to balance the incoming cold water flow with the incoming downstream hot water flow such that the two flows additively remain at a constant level. In addition, or alternatively, adjusting the geometry of the inlet orifice can change the annular wetted cross section, thereby producing a linearized outlet temperature change relative to plunger motion. According to exemplary embodiments, the linear range may be biased to the hot temperature delivery so that flowrate could be preserved better. Although an exemplary embodiment is described herein, it should be appreciated that the present subject matter may be used to balance outlet temperature and flowrate for different supply conditions or in different applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater appliance, comprising:
a tank defining an interior volume for holding water;
a cold water supply configured for directing cold water into the interior volume of the tank;
a heating assembly for heating water within the tank;
a hot water supply configured for directing heated water out of the interior volume of the tank; and
a mixing valve in fluid communication with the cold water supply and the hot water supply, the mixing valve being configured for selectively mixing the heated water from the hot water supply and the cold water from the cold water supply, the mixing valve comprising:
a valve body that defines a mixing chamber;
an inlet conduit that is fluidly coupled to the mixing chamber at an inlet orifice; and
a plunger valve mounted within the valve body, the plunger valve being moveable relative to the inlet orifice to regulate a flow of water through the inlet orifice, wherein a distal end of the plunger valve defines a profiled sealing face, the profiled sealing face and the inlet orifice being cooperative to permit a flow rate that is substantially proportional to a valve position.

2. The water heater appliance of claim 1, wherein a flow area of the inlet orifice is defined between the profiled sealing face of the plunger valve and the inlet conduit, wherein the flow area varies proportionally with the valve position of the plunger valve.

3. The water heater appliance of claim 1, wherein the profiled sealing face defines a conical taper toward the distal end of the plunger valve.

4. The water heater appliance of claim 1, wherein the profiled sealing face defines an arcuate, filleted, or parabolic corner.

5. The water heater appliance of claim 1, wherein the profiled sealing face defines a first region with a conical taper and a second region with an arcuate profile.

6. The water heater appliance of claim 1, wherein the inlet conduit comprises a profiled junction that defines the inlet orifice.

7. The water heater appliance of claim 6, wherein the profiled junction defines a conical taper away from mixing chamber.

8. The water heater appliance of claim 6, wherein the profiled junction defines an arcuate, filleted, or parabolic corner.

9. The water heater appliance of claim 1, wherein the inlet conduit is fluidly coupled to the cold water supply.

10. The water heater appliance of claim 1, wherein the inlet conduit is the hot water supply.

11. The water heater appliance of claim 1, wherein the mixing valve further comprises:
a drive body mounted within the valve body, the plunger valve being mounted within the drive body such that it is movable along a translation axis.

12. The water heater appliance of claim 11, wherein the plunger valve defines plunger threads and the drive body defines stationary threads, the plunger threads and the stationary threads engaging each other to move the plunger valve along the translation axis as the plunger valve is rotated.

13. The water heater appliance of claim 12, further comprising:
a drive motor operably coupled to the plunger valve for selectively rotating the plunger valve to move the plunger valve along the translation axis.

14. A mixing valve for a water heater appliance, the mixing valve comprising:
a valve body that defines a mixing chamber;
a hot water inlet conduit providing fluid communication between the mixing chamber and a hot water supply;
a cold water inlet conduit providing fluid communication between the mixing chamber and a cold water supply, the cold water inlet conduit comprising a profiled junction defining an inlet orifice; and
a plunger valve mounted within the valve body, the plunger valve being moveable relative to the inlet orifice to regulate a flow of water through the inlet orifice, wherein a distal end of the plunger valve defines a profiled sealing face, the profiled sealing face and the inlet orifice being cooperative to permit a flow rate that is substantially proportional to a valve position.

15. The mixing valve of claim 14, wherein a flow area of the inlet orifice is defined between the profiled sealing face of the plunger valve and the profiled junction, wherein the flow area varies proportionally with the valve position of the plunger valve.

16. The mixing valve of claim 14, wherein the profiled sealing face defines a conical taper toward the distal end of the plunger valve.

17. The mixing valve of claim 14, wherein the profiled sealing face defines an arcuate, filleted, or parabolic corner.

18. The mixing valve of claim 14, wherein the profiled sealing face defines a first region with a conical taper and a second region with an arcuate profile.

19. The mixing valve of claim 14, wherein the profiled junction defines a conical taper away from mixing chamber or an arcuate, filleted, or parabolic corner.

20. The mixing valve of claim 14, further comprising:
a drive body mounted within the valve body and defining stationary threads, the plunger valve being mounted within the drive body and defining plunger threads, the plunger threads and the stationary threads engaging each other to move the plunger valve along a translation axis as the plunger valve is rotated.
